(19) United States
(12) Patent Application Publication
(10) Pub. No.: US 2003/0189582 A1
(43) Pub. Date: Oct. 9, 2003

(54) Computerized musical score systems and methods

(76) Inventor: Maria Pinsky, Colorado Springs, CO (US)

Correspondence Address: HEWLETT-PACKARD COMPANY, Intellectual Property Administration, P.O. Box 272400, Fort Collins, CO, 80527-2400, US

(21) Appl. No.: 10/118,873

(22) Filed: Apr. 9, 2002

(51) Int. Cl. G09G 5/00

(52) U.S. Cl. 345/684

(57) ABSTRACT

A system is provided for presenting a synchronized musical score. The system has a controller and a plurality of computerized monitors. The monitors respond to the controller to display the musical score to musicians at the monitors. One or more data links between the controller and the monitors communicate information between the controller and the monitors. Optionally, a musical score database networks with the controller to provide the musical score to the controller. One or more of the monitors may have a media driver to provide the musical score to the one or more monitors. Physical media (e.g., CD ROM, magnetic media) may be inserted to the driver, the media encoding the musical score. Various controls at the monitors facilitate user selection of scrolling and display characteristics of the musical score.

### BACKGROUND OF THE INVENTION

The symphony operates today much like it did hundreds of years ago. First, musicians organize in a pattern about the conductor. Sheets of paper describe the musical score and adorn the stands in front of the musicians. The conductor then leads the arrangement, while the musicians turn sheets of the score and the audience listens.

The invention provides techniques and methods for computerized and synchronized musical score presentation. Other features of the invention will be apparent within the description that follows.

### SUMMARY OF THE INVENTION

The invention of one aspect replaces paper musical scores with computerized scores synchronized between musicians of an orchestra. Accordingly, the invention of one aspect alleviates the problems encountered by musicians of following a paper musical score with disorientations between page transitions. One or more computerized monitors display all or part of the underlying musical score. The monitor may be used individually, or multiple computerized monitors may operate collectively as a group with a master controller. The master controller typically resides with the conductor who commands the musicians. The computerized monitors show all, or at least a relevant part of, music as it is played, and may scroll upwards or downwards as each line of music is played. When computerized monitors are linked together, the conductor may independently adjust the speed of scrolling, as necessary.

In another aspect, a specialized software application drives the computerized monitor. The application may reside with physical media (e.g., a CD ROM) that also houses relevant musical score information for a particular monitor. In this way, a musician may physically insert the appropriate musical score to the monitor. Accordingly, in one aspect, the monitor includes a media driver such as a CD ROM or tape drive; the monitor also preferably has a display to view the score in motion across the display.

In another aspect, each musical score scrolls across a display monitor with a pre-defined scrolling speed. In another aspect, the monitor provides means to manually adjust the scrolling speed.

In one aspect, the computerized monitors for an orchestra are linked together by a data link (e.g., infrared, wireless, or physical bus) and to a master controller. The master controller typically resides where the conductor commands the orchestra. The link communicates information between the controller and the several monitors. In one aspect, the physical media representing the score only resides in a media driver at the controller, and then all or portions of the score are sent to the monitors over the link.

In another aspect, a cue is provided on the monitor display to play a specific musical score segment or piece. The cue may flash on the screen after selected music has been highlighted

In other aspects, the monitor may provide one or more of the following adjustments: speed adjustments on scrolling, depending on how the score is played; restarting of the musical score, to return to the beginning of the score; pausing of the musical score, to freeze the current position; manual scrolling of the score, to desired musician speed; and mixtures thereof.

In one aspect, a system is provided for presenting a synchronized musical score. The system has a controller and a plurality of computerized monitors. The monitors respond to the controller to display the musical score to musicians at the monitors. One or more data links between the controller and the monitors communicate information between the controller and the monitors.

In another aspect, a musical score database networks with the controller to provide the musical score to the controller. In another aspect, one or more of the monitors have a media driver to provide the musical score to the one or more monitors. Physical media (e.g., CD ROM, magnetic media) may be inserted to the driver, the media encoding the musical score.

Optionally, a first part of the musical score may be displayed on a first one of the computerized monitors and a second part of the musical score may be displayed to a second one of the computerized monitors. In this manner, the first part is displayed to a first musician type at the first one of the computerized monitors and a second part is displayed to a second musician type at the second one of the computerized monitors.

Optionally, scrolling speed may be adjusted at the monitors and/or by the controller.

Optionally, the controller may include a media driver to read musical score media in the delivery of the musical score to the plurality of monitors.

In another aspect, the invention provides a method for synchronizing display of a musical score to an orchestra, including the steps of: initiating commands at a controller networked with a plurality of monitors linked with the controller, the commands associated with the musical score; and automatically displaying and scrolling at least part of the musical score to each of the monitors in response to the commands. The method may include the step of reading the part of the musical score from physical media at each of the monitors and/or the step of communicating the part of the musical score from the controller to one or more of the monitors.

The invention is next described further in connection with preferred embodiments, and it will become apparent that various additions, subtractions, and modifications can be made by those skilled in the art without departing from the scope of the invention.

### BRIEF DESCRIPTION OF THE DRAWINGS

A more complete understanding of the invention may be obtained by reference to the drawings, in which:

FIG. 1 shows one computerized musical score system of the invention;

FIG. 2 shows one computerized monitor of the invention suitable for use in the system of FIG. 1;

FIG. 3 shows another computerized monitor of the invention suitable for use in the system of FIG.; and

FIG. 4 is a flowchart illustrating methodology of the invention for synchronizing musical scores among computerized orchestra monitors, in accord with the invention.

### DETAILED DESCRIPTION OF THE DRAWINGS

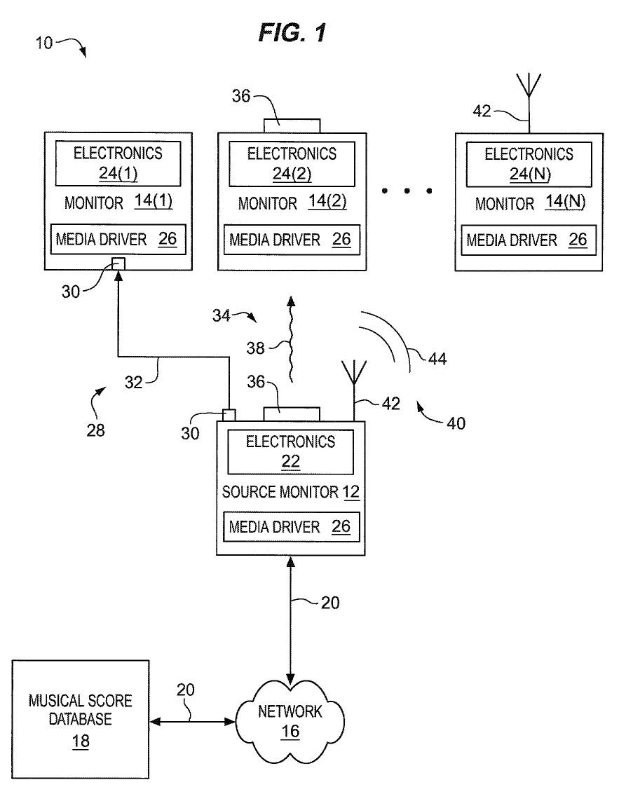

FIG. 1 shows one computerized musical score system 10 of the invention. A controller 12 synchronizes musical scores for display on a plurality of monitors 14, illustratively shown as N monitors 14(1), 14(2) . . . 14(N). In operation, a conductor may use controller 12 while orchestra musicians view up to N monitors 14(1), 14(2) . . . 14(N). In one embodiment, one musician type—e.g., French-hornist, celloist, or drummer—views one distinct monitor 14 so that different information may be provided at the distinct monitor 14, as described below.

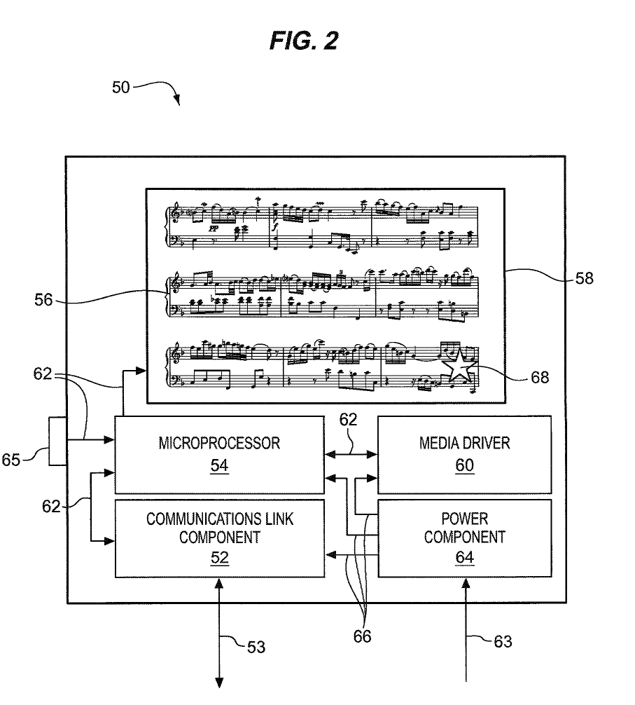

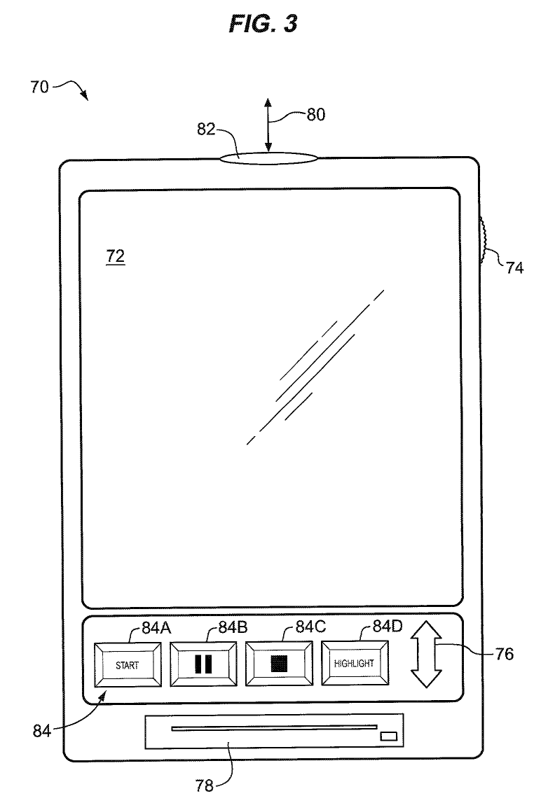

Each monitor 14 may for example be identical in construction. Controller 12 may also be constructed as a monitor 14, as a matter of design choice; in such an embodiment, controller 12 is a master monitor and monitors 14 are slave monitors. When devices 12, 14 are identical, their connectivity architecture linking devices 12, 14 determines which device is a master and which is the slave. For example, it is desirable to have the conductor's controller 12 operate to lead the musical score. FIGS. 2-3 show two different monitor configurations suitable for use as monitor 14.

In one embodiment, controller 12 connects with a network 16 (e.g., the Internet) and a musical score database 18 by a bus 20. Musical scores may be downloaded from database 18 through network 16 and to controller 12. These scores are then scrolled to monitors 14 so that respective musicians may play a synchronized musical score. In one embodiment, and as described below, a conductor at controller 12 controls delivery of the score to the various musicians at monitors 14.

Conductor and monitors 12, 14 include internal electronics, illustratively shown by electronics 22, 24, respectively. By way of example, and as described in connection with FIGS. 2-3, electronics 22, 24 include microprocessors and the like to provide operations described herein. Accordingly, conductor and monitors 12, 14 are “computerized.”

In one embodiment, conductor and monitors 12, 14 also include a media driver 26. Media driver 26 may be used to load physical storage media—e.g., CD ROM or magnetic tape—to respective devices 12, 14. This storage media then provides the musical score to respective monitors 14 in a controlled delivery as determined by the conductor at controller 12. Specifically, in this embodiment respective musician types may load different media information to media driver 26, at their respective monitors 14, so as to view musical score detail targeted to the musician type, yet all the while under control of controller 12.

Controller 12 communicates with monitors 14 by a communication link. FIG. 1 shows multiple communication links for illustrative purposes; however system 10 typically uses the same communication type throughout system 10. By way of example, FIG. 1 shows a bus communication link 28 providing a bus communication link between controller 12 and monitor 14(1). Bus interconnections 30 may provide the physical connection between controller 12, a network cable 32, and monitor 14(1), as shown. In another example, FIG. 1 shows an infrared communication link 34 between controller 12 and monitor 14(2). Infrared transmitter/receivers 36 may generate and receive infrared signals 38 to form infrared communication link 34. In yet another example, FIG. 1 shows a wireless communication link 40 between controller 12 and monitor 14(N). Wireless transceivers and antennas 42 may generate and receive wireless signals 44 to form wireless communication link 40. Those skilled in the art should appreciate that different forms and configurations of links 28, 34, 40 may exist without departing from the scope of the invention.

Accordingly, in one embodiment, network 16 and database 18 are not included with system 10. Rather, controller 12 drives the synchronized display of musical score information at monitors 14(1), 14(2) . . . 14(N); that information is however resident at each monitor 14 as physical media at media driver 26. In such an embodiment, communication links 28, 34, 40 generally provide control signals between controller 12 and monitors 14 so as to provide synchronized musical score information to musicians at monitors 14, and, if desired, other information as described herein.

Yet in another embodiment, media drivers 26 are not required, and links 28, 34, 40 provide all the musical score information. In this embodiment, musical score information is streamed to various monitors 14 over links 28, 34 and/or 40 to musicians at those monitors 14. Different musical score information may also be streamed to different musician types. The musical score information may be (a) locally stored or buffered at controller 12 and/or (b) streamed from database 18 to controller and monitors 12, 14 in real-time. In either case, for example, musical scores may be specific to various musician types. For example, system 10 may communicate French-hornist musical score information for a French horn musician at monitor 14(1) via link 28, celloist musical score information to a celloist at monitor 14(2) via link 34, and drummer musical score information to a drummer at monitor 14(N) via link 40. In each case, preferably, the conductor at controller 12 synchronizes delivery of information to the various musician types in a manner consistent with his or her musical taste, style and timing.

FIG. 2 shows one monitor 50 suitable for use as monitor 14, FIG. 1. A communication link component 52 provides for communications by and between monitor 50 and the conductor, over a communications link 53. By way of example, component 52 may be a wireless transceiver and link 53 is a wireless communication link 40 between monitor 50 and a controller 12. A microprocessor 54 controls monitor 50 in response to signals from component 52. By way of example, microprocessor 54 drives the display of musical score information 56 on a display 58, such as an LCD or plasma display. As described above, the musical score information may derive from link 53 and/or physical media (typically a CD ROM) in media driver 60. Interconnectivity and communication between devices 52, 54, 58, 60 may occur across one or more buses 62. A power component 64 provides overall power to monitor 50 through power interconnections 66. Component 64 may for example be a battery, or an interconnect to facility power over a power line 63. In one embodiment, a user enters certain commands to monitor 50 via a user interface 65; these commands may for example command scrolling characteristics of score 56, such as described in connection with FIG. 3.

FIG. 2 also illustrates that system 10 may provide queuing information 68 to a monitor 50. Information 68 can be used to tell the musician at monitor 50 that his portion of score 56 is about to begin. Information 68 may be used for other purposes too, for example to provide private communications between the conductor and the musician. Information 68 may be sent from the conductor to the musician over link 53.

A software application and/or firmware may reside with microprocessor 54 to drive the display of information 56 across display 58. The application may also reside with the physical media (e.g., CD ROM) containing the musical score if used within media driver 60, as a matter of design choice.

FIG. 3 shows another monitor 70 constructed according to the invention. Monitor 70 has a display 72 to display musical score and other information (e.g., queuing information 68) to a musician at monitor 70. Display 72 is preferably a “touch screen” display that a musician can touch to communicate with system 10 and/or to change the display of information thereon. Monitor 70 may include a scrolling wheel 74 that the musician can also use to adjust or scroll musical score information on display 72. A scroll speed adjustment 76 provides a mechanism through which the musician may independently adjust how a musical score scrolls through display 72. As above, the musical score information may derive from physical media within a media driver 78, and/or from a communication link 80 with monitor 70. An infrared communication port 82 may for example provide the communication link 80 to communicate with the conductor; for example, port 82 may be an infrared device 36 to provide communications link 34, FIG. 1.

Monitor 70 also has other controls and buttons 84. A start button 84A may be used to begin scrolling of musical score information across display 72. A pause scrolling button 84B may be used to pause the information on display 72. A stop scrolling button 84C may be used to stop scrolling of information on display 72. A highlight button 84D may be used to highlight the remaining portions of a musical score, on display 72, so as to help identify past and future portions of the musical score; this feature assists the musician in keeping track of score location. In one embodiment, controls and buttons 84 direct an internal microprocessor to perform the commanded functions, such as described in connection with user interface 65 and microprocessor 54, FIG. 2. Those skilled in the art should appreciate that touch screen features of display 72, wheel 74, and controls and buttons 84 are also not required in a system 10, FIG. 1. That is, system 10 may independently control the scrolling and motion of the score across display 72 without user interaction, as a matter of design choice.

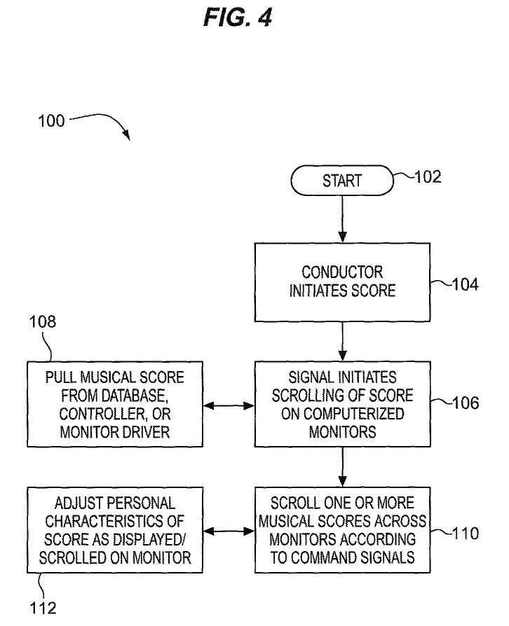

FIG. 4 shows a flowchart 100 illustrating methodology of the invention for synchronizing musical scores amongst musicians in an orchestra. After start 102, a conductor initiates the musical score, at step 104. The conductor may initiate the score by several techniques, including pressing a button on the controller which in turn relays a start command across the links to connected computerized monitors amongst the orchestra, step 106. The musical score information for a particular monitor may derive from a database, controller and/or internal media at the monitor, as denoted by step 108. At step 110, the musical score scrolls across the monitors according to conductor commands at the controller; the scores may be different across the monitors according to musician type. If desired, a musician may separately control display and scroll characteristics of personal monitors at step 112.

Those skilled in the art should appreciate that steps 102-112 are illustrative and not limiting. Steps 102-112 may be reordered, augmented or modified without departing from the scope of the invention, such as in accordance with the attached claims. Since certain changes may be made in the above methods and systems without departing from the scope of the invention, it is intended that all matter contained in the above description or shown in the accompanying drawing be interpreted as illustrative and not in a limiting sense. It is also to be understood that the following claims are to cover all generic and specific features of the invention described herein, and all statements of the scope of the invention which, as a matter of language, might be said to fall there between.

What is claimed is:

1. A system for presenting a synchronized musical score, comprising:
a controller and a plurality of computerized monitors, the monitors responsive to the controller to display the musical score to musicians at the monitors; and
one or more data links between the controller and the monitors for communicating information between the controller and the monitors.

2. A system of claim 1, further comprising a musical score database networked with the controller for providing the musical score to the controller.

3. A system of claim 1, one or more of the monitors having a media driver for providing the musical score to the one or more monitors.

4. A system of claim 3, further comprising one or more physical media for insertion to the driver and representing the musical score.

5. A system of claim 4, the physical media being selected from the group consisting essentially of CD ROM, magnetic tape and magnetic disk.

6. A system of claim 1, further comprising means for providing a first part of the musical score to a first one of the computerized monitors and for providing a second part of the musical score to a second one of the computerized monitors, wherein the first part is displayed to a first musician type at the first one of the computerized monitors, and wherein a second part is displayed to a second musician type at the second one of the computerized monitors.

7. A system of claim 1, wherein the controller comprises means for adjusting scrolling speed of the musical score displayed on the monitors.

8. A system of claim 1, wherein one or more of the monitors comprise means for adjusting scrolling speed of the musical score displayed on the one or more monitors.

9. A system of claim 1, wherein the controller comprises a media driver for providing the musical score to the monitors.

10. A system of claim 9, further comprising one or more physical media for insertion to the driver and representing the musical score, the musical score communicated to the monitors over the links.

11. A system of claim 10, the physical media being selected from the group consisting essentially of CD ROM, magnetic tape and magnetic disk.

12. A system of claim 1, the data links comprising one or more of a bus communications link, a wireless communications link, and an infrared communications link.

13. A system of claim 1, further comprising means for displaying queuing information on one or more of the monitors.

14. A computerized monitor for displaying information associated with a musical score, comprising: a display; a microprocessor responsive to command signals to initiate and scroll of at least part of the musical score on the display.

15. A monitor of claim 14, further comprising one or more user interface buttons for controlling one or both of scroll and display characteristics of the musical score on the display.

16. A monitor of claim 14, further comprising physical storage media for storing the musical score, and a media driver for reading the physical storage media, the physical storage media comprising one of CD ROM, magnetic tap and magnetic disk.

17. A monitor of claim 14, further comprising a communications link component for receiving the command signals and information representative of the musical score.

18. A method for synchronizing display of a musical score to an orchestra, comprising the steps of: initiating commands at a controller networked with a plurality of monitors linked with the controller, the commands associated with the musical score; and automatically displaying and scrolling at least part of the musical score to each of the monitors in response to the commands.

19. A method of claim 18, further comprising the step of reading the part of the musical score from physical media at each of the monitors.

20. A method of claim 18, further comprising communicating the part of the musical score from the controller to one or more of the monitors.
